(19) United States
(12) Patent Application Publication
(10) Pub. No.: US 2026/0343407 A1
(43) Pub. Date: Oct. 29, 2026

(54) HANDLING OF WIRELESS DEVICE (WD) TIMERS AND TRIGGERS DURING NETWORK DISCONTINUOUS TRANSMISSION AND RECEPTION

(71) Applicant: Telefonaktiebolaget LM Ericsson (publ), Stockholm (SE)

(72) Inventors: Lian ARAUJO, Solna (SE); Sladana JOSILO, Solna (SE); Ali NADER, Malmö (SE); Nianshan SHI, Järfälla (SE); Ajit NIMBALKER, Dublin, CA (US); Sina MALEKI, Malmö (SE)

(21) Appl. No.: 19/117,823

(22) PCT Filed: Oct. 10, 2023
(86) PCT No.: PCT/EP2023/078001

§ 371 Date: Apr. 2, 2025

Related U.S. Application Data
(60) Provisional application No. 63/414,664, filed on Oct. 10, 2022.

(51) Int. Cl. H04W 52/02; H04W 76/28

(52) U.S. Cl. CPC H04W 52/0216; H04W 52/0206; H04W 76/28

(57) ABSTRACT

A method, network node and wireless device (WD) for handling wireless device timers and triggers during discontinuous reception and transmission (DTRX) are disclosed. According to one aspect, a method in a WD includes receiving a timer value from the network node. The network node includes starting a timer having a duration based at least in part on the timer value, the timer value being based at least in part on whether the network node is in one of an off occasion and an on-occasion.

### TECHNICAL FIELD

The present disclosure relates to wireless communications, and in particular, to handling wireless device (WD) timers and triggers during discontinuous reception and transmission (DTRX)

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### Network Node Power Consumption

Energy consumption is a considerable challenge for 5G systems today where a major contributor to the energy consumption is the radio unit of the radio access network (RAN). The network node power consumption for NR is said to be lower than network node power consumption for LTE because of its lean design, i.e., no cell-specific reference signal (CRS) and the synchronization signal block (SSB) periodicity is by default, 20 ms. However, NR in the current implementation may consume more energy compared to LTE, partly due to higher bandwidths, shorter transmission time intervals (TTIs) and a massive number of antennas. This is still evident even at times when cells and beams are lightly loaded or serve no traffic or no users at all. One basic method for saving network node energy is to simply turn off a gNB or cell completely when it is seen or predicted that there is little or no traffic or even no user in the cell.

### Discontinuous Reception

NR, similar to LTE, includes mechanisms for discontinuous reception (DRX) for the WDs in order to reduce WD power consumption. DRX may be used both in radio resource control (RRC) connected mode (C-DRX) and RRC Idle/Inactive (DRX) and serves as a common agreement between the WD and the network node that upon any downlink (DL) traffic, the network node will only try to contact the WD during the on-time of the DRX pattern. Based on a configured DRX cycle, the WD then only needs to monitor the DL channels according to the agreement and sleep otherwise. When it comes to uplink (UL) traffic, the WD may initiate connection regardless of the DRX configuration, i.e., the network node has to be prepared to receive UL at any time.

### WD Timers and Triggers

Multiple timers are defined in 3GPP Technical Standard (TS) 38.331, e.g. V17.2.0 (2022-09), to control the WD behavior. Those timers are generally defined by actions to be performed by the WD upon Start, Stop and At Expiry of the timer as depicted in the examples in the table below.

| Timer | Start | Stop | At expiry |
|---|---|---|---|
| T300 | Upon transmission | Upon reception of | Perform the |
| | of | RRCSetup or RRCReject | actions as |
| | RRCSetupRequest. | message, cell re-selection, | specified in |
| | | the (re)selected L2 U2N | 5.3.3.7. |
| | | Relay WD becomes | |
| | | unsuitable, and upon | |
| | | abortion of connection | |
| | | establishment by upper | |
| | | layers. | |
| T301 | Upon transmission | Upon reception of | Go to RRC_IDLE |
| | of | RRCReestablishment or | |
| | RRCReestabilshment | RRCSetup message as well | |
| | Request | as when the selected cell | |
| | | becomes unsuitable or the | |
| | | (re)selected L2 U2N Relay | |
| | | WD becomes unsuitable. | |
| T302 | Upon reception of | Upon entering | Inform upper |
| | RRCReject while | RRC_CONNECTED or | layers about |
| | performing RRC | RRC_IDLE, upon cell re- | barring alleviation |
| | connection | selection, upon cell change | as specified in |
| | establishment or | due to relay (re)selection, | 5.3.14.4 |
| | resume, upon | and upon reception of | |
| | reception of | RRCReject message. | |
| | RRCRelease with | | |
| | waitTime. | | |
| T304 | Upon reception of | Upon successful | For T304 of |
| | RRCReconfiguration | completion of random | MCG, in case of |
| | message including | access on the | the handover from |
| | reconfigurationWith | corresponding SpCell | NR or intra-NR |
| | Sync for the MCG, | For T304 of SCG, upon | handover, initiate |
| | or upon reception of | SCG release | the RRC re- |
| | RRCReconfiguration | | establishment |
| | message including | | procedure; In case |
| | reconfigurationWith | | of handover to |
| | Sync for the SCG not | | NR, perform the |
| | indicated as | | actions defined in |
| | deactivated in the | | the specifications |
| | NR or E-UTRA | | applicable for the |
| | message containing | | source RAT. If |
| | the | | any DAPS bearer |
| | RRCReconfiguration | | is configured and |
| | message or upon | | if there is no RLF |
| | conditional | | in source PCell, |
| | reconfiguration | | initiate the failure |
| | execution i.e., when | | information |
| | applying a stored | | procedure. |
| | RRCReconfiguration | | For T304 of SCG, |
| | message including | | inform network |
| | reconfigurationWith | | about the |
| | Sync. | | reconfiguration |
| | | | with sync failure |
| | | | by initiating the |
| | | | SCG failure |
| | | | information |
| | | | procedure as |
| | | | specified in 5.7.3. |
| T310 | Upon detecting | Upon receiving N311 | If the T310 is kept |
| | physical layer | consecutive in-sync | in MCG: If AS |
| | problems for the | indications from lower | security is not |
| | SpCell i.e., upon | layers for the SpCell, upon | activated: go to |
| | receiving N310 | receiving | RRC_IDLE else: |
| | consecutive out-of- | RRCReconfiguration with | initiate the MCG |
| | sync indications | reconfigurationWithSync | failure |
| | from lower layers. | for that cell group, upon | information |
| | | reception of | procedure as |
| | | MobilityFromNRCommand, | specified in 5.7.3b |
| | | upon the reconfiguration | or the connection |
| | | of rlf-TimersAndConstant, | re-establishment |
| | | upon initiating the | procedure as |
| | | connection re- | specified in 5.3.7 |
| | | establishment procedure, | or the procedure |
| | | upon conditional | as specified in |
| | | reconfiguration execution | 5.3.10.3 if any |
| | | i.e., when applying a | DAPS bearer is |
| | | stored | configured. |
| | | RRCReconfiguration | If the T310 is kept |
| | | message including | in SCG, Inform E- |
| | | reconfigurationWithSync | UTRAN/NR |
| | | for that cell group, and | about the SCG |
| | | upon initiating the MCG | radio link failure |
| | | failure information | by initiating the |
| | | procedure. | SCG failure |
| | | Upon SCG release, if the | information |
| | | T310 is kept in SCG. | procedure as |
| | | | specified in 5.7.3. |
| T311 | Upon initiating the | Upon selection of a | Enter RRC_IDLE |
| | RRC connection re- | suitable NR cell, or upon | |
| | establishment | selection of a suitable L2 | |
| | procedure | U2N Relay WD, or a cell | |
| | | using another RAT. | |
| T312 | If T312 is configured | Upon receiving N311 | If the T312 is kept |
| | in MCG: Upon | consecutive in-sync | in MCG initiate |
| | triggering a | indications from lower | the MCG failure |
| | measurement report | layers for the SpCell, | information |
| | for a measurement | receiving | procedure as |
| | identity for which | RRCReconfiguration with | specified in 5.7.3b |
| | T312 has been | reconfigurationWithSync | or the connection |
| | configured and | for that cell group, upon | re-establishment |
| | useT312 has been set | reception of | procedure. |
| | to true, while T310 | MobilityFromNRCommand, | If the T312 is kept |
| | in PCell is running. | upon initiating the | in SCG, Inform E- |
| | If T312 is configured | connection re- | UTRAN/NR |
| | in SCG and useT312 | establishment procedure, | about the SCG |
| | has been set to true: | upon the reconfiguration | radio link failure |
| | Upon triggering a | of rlf-TimersAndConstant, | by initiating the |
| | measurement report | upon initiating the MCG | SCG failure |
| | for a measurement | failure information | information |
| | identity for which | procedure, upon | procedure.as |
| | T312 has been | conditional reconfiguration | specified in 5.7.3. |
| | configured, while | execution i.e., when | |
| | T310 in PSCell is | applying a stored | |
| | running. | RRCReconfiguration | |
| | | message including | |
| | | reconfigurationWithSync | |
| | | for that cell group, and | |
| | | upon the expiry of T310 in | |
| | | corresponding SpCell. | |
| | | Upon SCG release, if the | |
| | | T312 is kept in SCG | |
| T316 | Upon transmission | Upon receiving | Perform the |
| | of the | RRCRelease, | actions as |
| | MCGFailureInformation | RRCReconfiguration with | specified in |
| | message | reconfigurationwithSync | 5.7.3b.5. |
| | | for the PCell, | |
| | | MobilityFromNRCommand, | |
| | | or upon initiating the re- | |
| | | establishment procedure | |
| T319 | Upon transmission of | Upon reception of | Perform the |
| | RRCResumeRequest or | RRCResume, RRCSetup, | actions as |
| | RRCResumeRequest | RRCRelease, RRCRelease | specified in |
| | 1 when the resume | with suspendConfig or | 5.3.13.5. |
| | procedure is not | RRCReject message, upon | |
| | initiated for SDT. | cell re-selection and upon | |
| | | relay (re)selection. | |
| T319a | Upon transmission of | Upon reception of | Perform the |
| | RRCResumeRequest or | RRCResume, RRCSetup, | actions as |
| | RRCResumeRequest | RRCRelease, RRCReject | specified in |
| | 1 when the resume | message or upon failure to | 5.3.13.5. |
| | procedure is initiated | resume RRC connection | |
| | for SDT. | for SDT as specified in | |
| | | 5.3.13.5. | |
| T320 | Upon reception of | Upon entering | Discard the cell |
| | t320 or upon cell | RRC_CONNECTED, | reselection |
| | (re)selection to NR | upon reception of | priority |
| | from another RAT | RRCRelease, when PLMN | information |
| | with validity time | selection or SNPN | provided by |
| | configured for | selection is performed on | dedicated |
| | dedicated priorities | request by NAS, when the | signalling. |
| | (in which case the | WD enters RRC_IDLE | |
| | remaining validity | from RRC_INACTIVE, or | |
| | time is applied). | upon cell (re)selection to | |
| | | another RAT (in which | |
| | | case the timer is carried on | |
| | | to the other RAT). | |
| T321 | Upon receiving | Upon acquiring the | Initiate the |
| | measConfig | information needed to set | measurement |
| | including a | all fields of cgi-info, upon | reporting |
| | reportConfig with | receiving measConfig that | procedure, stop |
| | the purpose set to | includes removal of the | performing the |
| | reportCGI | reportConfig with the | related |
| | | purpose set to reportCGI | measurements. |
| | | and upon detecting that a | |
| | | cell is not broadcasting | |
| | | SIB1. | |
| T322 | Upon receiving | Upon acquiring the SFTD | Initiate the |
| | measConfig | measurement results, upon | measurement |
| | including | receiving measConfig that | reporting |
| | reportConfigNR with | includes removal of the | procedure, stop |
| | the purpose set to | reportConfig with the | performing the |
| | reportSFTD and drx- | purpose set to | related |
| | SFTD-NeighMeas is | reportSFTD. | measurements. |
| | set to true. | | |
| T325 | Upon reception of | | Stop |
| | RRCRelease | | deprioritisation of |
| | message with | | all frequencies or |
| | deprioritisationTimer. | | NR signalled by |
| | | | RRCRelease. |
| T330 | Upon receiving | Upon log volume | Perform the |
| | LoggedMeasurement | exceeding the suitable WD | actions specified |
| | Configuration | memory, upon initiating | in 5.5a.1.4 |
| | message | the release of | |
| | | LoggedMeasurementConfiguration | |
| | | procedure | |
| T331 | Upon receiving | Upon receiving RRCSetup, | Perform the |
| | RRCRelease | RRCResume, RRCRelease | actions as |
| | message with | with idle/inactive | specified in |
| | measIdleDuration | measurement | 5.7.8.3. |
| | | configuration, upon cell | |
| | | selection/reselection to a | |
| | | cell that does not belong to | |
| | | the validityArea (if | |
| | | configured), or upon cell | |
| | | re-selection to another | |
| | | RAT. | |
| T342 | Upon transmitting | Upon releasing | No action. |
| | WDAssistanceInformation | delayBudgetReportingConfig | |
| | message with | during the connection | |
| | DelayBudgetReport. | re-establishment/resume | |
| | | procedures, and upon | |
| | | receiving | |
| | | delayBudgetReportingConfig | |
| | | set to release. | |
| T345 | Upon transmitting | Upon releasing | No action. |
| | WDAssistanceInformation | overheatingAssistance | |
| | message with | during the connection re- | |
| | overheatingAssistance | establishment procedure, | |
| | | upon initiating the | |
| | | connection resumption | |
| | | procedure, and upon | |
| | | receiving | |
| | | overheatingAssistanceConfig | |
| | | set to release. | |
| T346a | Upon transmitting | Upon releasing drx- | No action. |
| (The WD | WDAssistanceInformation | PreferenceConfig during | |
| maintains | message with | the connection re- | |
| one | drx-Preference. | establishment/resume | |
| instance | | procedures, upon receiving | |
| of this | | drx-PreferenceConfig set | |
| timer per | | to release, or upon | |
| cell | | performing MR-DC | |
| group) | | release. | |
| T346b | Upon transmitting | Upon releasing maxBW- | No action. |
| (The WD | WDAssistanceInformation | PreferenceConfig during | |
| maintains | message with | the connection re- | |
| one | maxBW-Preference. | establishment/resume | |
| instance | | procedures, upon receiving | |
| of this | | maxBW-PreferenceConfig | |
| timer per | | set to release, or upon | |
| cell | | performing MR-DC | |
| group) | | release. | |
| T346c | Upon transmitting | Upon releasing maxCC- | No action. |
| (The WD | WDAssistanceInformation | PreferenceConfig during | |
| maintains | message with | the connection re- | |
| one | maxCC-Preference. | establishment/resume | |
| instance | | procedures, upon receiving | |
| of this | | maxCC-PreferenceConfig | |
| timer per | | set to release, or upon | |
| cell | | performing MR-DC | |
| group) | | release. | |
| T346d | Upon transmitting | Upon releasing | No action. |
| (The WD | WDAssistanceInformation | maxMIMO- | |
| maintains | message with | LayerPreferenceConfig | |
| one | maxMIMO- | during the connection re- | |
| instance | Layer Preference. | establishment/resume | |
| of this | | procedures, upon receiving | |
| timer per | | maxMIMO- | |
| cell | | LayerPreferenceConfig set | |
| group) | | to release, or upon | |
| | | performing MR-DC | |
| | | release. | |
| T346e | Upon transmitting | Upon releasing | No action. |
| (The WD | WDAssistanceInformation | minSchedulingOffsetPreferenceConfig | |
| maintains | message with | during the | |
| one | minSchedulingOffset | connection re- | |
| instance | Preference. | establishment/resume | |
| of this | | procedures, upon receiving | |
| timer per | | minSchedulingOffsetPreferenceConfig | |
| cell | | set to release, | |
| group) | | or upon performing MR- | |
| | | DC release. | |
| T346f | Upon transmitting | Upon releasing | No action. |
| | WDAssistanceInformation | releasePreferenceConfig | |
| | message with | during the connection re- | |
| | releasePreference. | establishment/resume | |
| | | procedures, or upon | |
| | | receiving | |
| | | releasePreferenceConfig | |
| | | set to release. | |
| T346g | Upon transmitting | Upon receiving | Perform the |
| | WDAssistanceInformation | RRCRelease, or upon | actions as |
| | message with | entering Idle state, or upon | specified in |
| | musim- | receiving musim- | 5.3.8.6. |
| | PreferredRRC-State. | LeaveAssistanceConfig set | |
| | | to release. | |
| T346h | Upon transmitting | Upon releasing musim- | No action. |
| | WDAssistanceInformation | GapAssistanceConfig | |
| | message with | during the connection re- | |
| | musim- | establishment/resume | |
| | GapPreferenceList | procedures, or upon | |
| | Information. | receiving musim- | |
| | | GapAssistanceConfig set | |
| | | to release. | |
| T346i | Upon transmitting | Upon RRC connection re- | No action. |
| | WDAssistanceInformation | establishment/resume or | |
| | message with | upon receiving scg- | |
| | scg- | DeactivationPreferenceConfig | |
| | DeactivationPreference | set to release. | |
| T346j | Upon transmitting | Upon releasing rlm- | No action. |
| (The WD | WDAssistanceInformation | RelaxationReportingConfig | |
| maintains | message with | during the connection re- | |
| one | rlm- | establishment/resume | |
| instance | RelaxationReporting | procedures, upon receiving | |
| of this | Config. | rlm- | |
| timer per | | RelaxationReportingConfig | |
| cell | | set to release, or upon | |
| group) | | performing MR-DC | |
| | | release. | |
| T346k | Upon transmitting | Upon releasing bfd- | No action. |
| (The WD | WDAssistanceInformation | RelaxationReportingConfig | |
| maintains | message with | during the connection re- | |
| one | bfd- | establishment/resume | |
| instance | RelaxationReporting | procedures, upon receiving | |
| of this | Config. | bfd- | |
| timer per | | RelaxationReportingConfig | |
| cell | | set to release, or upon | |
| group) | | performing MR-DC | |
| | | release. | |
| T350 | Upon transmitting | Upon acquiring the | No action |
| | DedicatedSIBRequest | requested SIB(s) or | |
| | message with | posSIB(s), upon releasing | |
| | requestedSIB-List | onDemandSIB-Request | |
| | and/or | during the connection re- | |
| | requestedPosSIB- | establishment procedures, | |
| | List. | upon receiving | |
| | | onDemandSIB-Request set | |
| | | to release, upon reception | |
| | | of RRCRelease or upon | |
| | | successful change of PCell | |
| | | while in | |
| | | RRC_CONNECTED. | |
| T380 | Upon reception of | Upon reception of | Perform the |
| | t380 in RRCRelease. | RRCResume, RRCSetup or | actions as |
| | | RRCRelease. | specified in |
| | | | 5.3.13. |
| T390 | When access attempt | Upon cell (re)selection, | Perform the |
| | is barred at access | upon cell change due to | actions as |
| | barring check for an | relay (re)selection, upon | specified in |
| | Access Category. | entering | 5.3.14.4. |
| | The WD maintains | RRC_CONNECTED, | |
| | one instance of this | upon reception of | |
| | timer per Access | RRCReconfiguration | |
| | Category. | including | |
| | | reconfigurationWithSync, | |
| | | upon change of PCell | |
| | | while in | |
| | | RRC_CONNECTED, | |
| | | upon reception of | |
| | | MobilityFromNRCommand, | |
| | | or upon reception of | |
| | | RRCRelease. | |
| T400 | Upon transmission | Upon reception of | Perform the |
| | of | RRCReconfigurationFailureSidelink | Sidelink radio link |
| | RRCReconfiguration | or | failure related |
| | Sidelink | RRCReconfigurationCompleteSidelink | actions as |
| | | | specified in |
| | | | 5.8.9.3. |
| T420 | Upon reception of | Upon successfully sending | Perform the RRC |
| | the RRC | RRCReconfigurationComplete | re-establishment |
| | reconfiguration | message (i.e., PC5 | procedure as |
| | message indicating | RLC acknowledge is | specified in 5.3.7. |
| | direct-to-indirect | received from target L2 | |
| | path switch | U2N Relay WD) | |

As the network node is not aware of potential UL traffic demands of the WDs, it cannot freely employ sleeping patterns. If the network node would go to sleep, it would lead to several problems. One of the problems concerns the timers defined to be used by the WDs as specified in 3GPP TS 38.331, e.g. V17.2.0 (2022-09). These timers may be triggered or stopped depending on several conditions, and at their expiry, there are certain actions that the network node needs to perform as described in 3GPP TS 38.331, e.g. V17.2.0 (2022-09). However, the current 3GPP specifications do not specify what to do if a timer expires during the time the network node is in sleep mode. This may cause issues since the actions that the network node is supposed to perform upon a timer expiration may be delayed. The WD may misinterpret the delay (or absence of the network node actions) and trigger a sequence of other unnecessary actions, which may adversely affect the overall system performance. For example, these unnecessary actions may negatively affect the WD's quality of experience, increase the WD power consumption, and increase the burden on the network node side due to the need to deal with subsequent actions that the WD triggered as a response to the misinterpreted delay.

### SUMMARY

It may be an object of the invention to provide measures with which a network node can use a sleeping pattern to save energy without negatively impacting or with small negative impact on a performance of the wireless device.

Some embodiments advantageously provide methods, network nodes and WDs for handling wireless device timers and triggers during discontinuous reception and transmission (DTRX).

Some embodiments address handling the timers defined in Section 7.1.1 in 3GPP TS 38.331, e.g. V17.2.0 (2022-09), during the periods that a network node is in sleep mode.

The WD may be informed about the network sleeping patterns and thus may trigger procedures based at least in part on this pattern. Some embodiments provide for specification of the method for handling the timers from 3GPP TS 38.331, e.g. V17.2.0 (2022-09), during the periods the network node is in sleep mode. Some embodiments prevent the WD from misinterpreting the delay in network node actions upon timer expiration, and hence from triggering unnecessary actions that may negatively affect both the network node and the WD itself (e.g., falsely detecting radio link failure (while the network is sleeping) or re-attempting to send a UL message during the network sleeping period).

According to one aspect, a network node configured to communicate with a wireless device, WD, is provided. The network node is configured to configure the WD with a first timer value for determining a first duration of a first timer to be used when the network node is operating in an always-on mode having a continuous on occasion. The network node is also configured to configure the WD with a second timer value for determining a second duration of a second timer to be used when the network node is operating in an on-off mode having on occasions and off occasions.

According to this aspect, in some embodiments, the second duration is a duration between a start time and a stop time of the second timer, respectively. In some embodiments, the second timer value is a scaling factor from which the WD determines the second duration. In some embodiments, the scaling factor is based at least in part on a length of a discontinuous transmission and reception, DTRX, cycle. In some embodiments, the first timer is associated with WD operation according to a first wireless access communication standard and the second timer is associated with WD operation according to a second wireless communication standard. In some embodiments, the network node is configured to transmit to the WD an indication of a sleep pattern of the network node. In some embodiments, the first and/or second timers is a duration timer, an inactivity timer, a discontinuous transmission and reception, DTRX, cycle, a reference signal transmission timer, a physical random access channel, PRACH, occasion timer, an uplink or downlink reception or transmission timer, and a measurement window timer. In some embodiments, the first and/or second timers is a duration timer indicating a window of time within which the WD may expect a transmission from the network node or within which the WD may transmit an uplink signal. In some embodiments, the window of time is aligned with at least one of a discontinuous reception and a paging occasion. In some embodiments, at least one of the first and second timers is one of a radio resource control, RRC, timer and a predefined timer.

According to another aspect, a method in a network node configured to communicate with a wireless device, WD, is provided. The method includes configuring the WD with a first timer value for determining a first duration of a first timer to be used when the network node is operating in an always-on mode having a continuous on occasion; and configuring the WD with a second timer value for determining a second duration of a second timer to be used when the network node is operating in an on-off mode having on occasions and off occasions.

According to this aspect, in some embodiments, the second duration is a duration between a start time and a stop time of the second timer, respectively. In some embodiments, the second timer value is a scaling factor from which the WD determines the second duration. In some embodiments, the scaling factor is based at least in part on a length of a discontinuous transmission and reception, DTRX, cycle. In some embodiments, the first timer is associated with WD operation according to a first wireless access communication standard and the second timer is associated with WD operation according to a second wireless communication standard. In some embodiments, the method includes transmitting to the WD an indication of a sleep pattern of the network node. In some embodiments, at least one of the first and second timers is a duration timer, an inactivity timer, a discontinuous transmission and reception, DTRX, cycle, a reference signal transmission timer, a physical random access channel, PRACH, occasion timer, an uplink or downlink reception or transmission timer, and a measurement window timer. In some embodiments, at least one of the first and second timers is a duration timer indicating a window of time within which the WD may expect a transmission from the network node or within which the WD may transmit an uplink signal. In some embodiments, the window of time is aligned with at least one of a discontinuous reception and a paging occasion. In some embodiments, at least one of the first and second timers is one of a radio resource control, RRC, timer and a predefined timer.

According to yet another aspect, a network node configured to communicate with a wireless device, WD, is provided. The network node is configured to transmit to the wireless device an indication that the network node is operating in a sleeping occasion.

According to this aspect, in some embodiments, the indication includes at least one of: Radio Resource Control, RRC, configuration signaling regarding handling of the timer and/or triggering the associated action; System information, SI, broadcast signaling regarding handling of the timer and/or triggering the associated action; Downlink control information, DCI, signaling regarding handling of the timer and/or triggering the associated action, and Media Access Control, MAC, signaling regarding handling of the timer and/or triggering the associated action. In some embodiments, the network node is configured to transmit to the wireless device configuration information regarding another timer and/or the another timer value to be used during the sleeping occasion of the network node. In some embodiments, the configuration information includes scaling parameters for the another timer value. In some embodiments, the network node is configured to transmit to the wireless device an instruction to suspend handling of a timer in the wireless device and a further instruction to resume handling of the timer.

According to another aspect, a method implemented in a network node configured to communicate with a wireless device, WD, includes transmitting to the wireless device an indication that the network node is operating in a sleeping occasion.

According to this aspect, in some embodiments, the indication includes at least one of: Radio Resource Control, RRC, configuration signaling regarding handling of the timer and/or triggering the associated action; System information, SI, broadcast signaling regarding handling of the timer and/or triggering the associated action; Downlink control information, DCI, signaling regarding handling of the timer and/or triggering the associated action; and Media Access Control, MAC, signaling regarding handling of the timer and/or triggering the associated action. In some embodiments, the method further including transmitting to the wireless device configuration information regarding another timer and/or the another timer value to be used during the sleeping occasion of the network node. In some embodiments, the configuration information includes scaling parameters for the another timer value. In some embodiments, the method further includes transmitting to the wireless device an instruction to suspend handling of a timer in the wireless device and a further instruction to resume handling of the timer.

According to another aspect, a wireless device (WD) configured to communicate with a network node is provided. The WD is configured to: receive a first timer value for determining a first duration of a first timer to be used when the network node is operating in an always-on mode having a continuous on occasion; receive a second timer value for determining a second duration of a second timer to be used when the network node is operating in an on-off mode having on occasions and off occasions; and in response to a trigger, start or stop the second timer only during an on occasion.

According to this aspect, in some embodiments, when the trigger is received during an off occasion, starting or stopping the second timer is postponed until an end of the off occasion. In some embodiments, the WD is configured to, when the second timer expires during an off occasion, postpone performance of an action to be performed at an expiry of the second timer until a next on occasion. In some embodiments, the WD is configured to, when the second timer expires during an off occasion, postpone performance of an action to be performed at an expiry of the second timer until after a period of delay. In some embodiments, the delay is configured by the network node. In some embodiments, the WD is configured to pause the second timer when an off occasion begins and resume the second timer when the off occasion ends. In some embodiments, the WD is configured to stop the second timer when an off occasion begins. In some embodiments, the second timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer. In some embodiments, the WD is configured to perform an action during an off occasion only when the action does not depend on a transmission or a reception. In some embodiments, the second duration indicates a window of time within which the WD may expect a transmission from the network node or within which the WD may transmit an uplink signal. In some embodiments, the window of time is aligned with at least one of a discontinuous reception and a paging occasion. In some embodiments, the WD is configured to apply a first delay before triggering an action when the second timer one of starts, expires and stops during an off-occasion, and to apply a second delay different from the first delay when the second timer one of starts, expires and stops during an on-occasion.

According to another aspect, a method in a wireless device (WD) configured to communicate with a network node is provided. The method includes receiving a first timer value for determining a first duration of a first timer to be used when the network node is operating in an always-on mode having a continuous on occasion; receiving a second timer value for determining a second duration of a second timer to be used when the network node is operating in an on-off mode having on occasions and off occasions; and in response to a trigger, starting or stopping the second timer only during an on occasion.

According to this aspect, in some embodiments, when the trigger is received during an off occasion, starting or stopping the second timer is postponed until an end of the off occasion. In some embodiments, the method includes, when the second timer expires during an off occasion, postponing performance of an action to be performed at an expiry of the second timer until a next on occasion. In some embodiments, the method includes, when the second timer expires during an off occasion, postponing performance of an action to be performed at an expiry of the second timer until after a period of delay. In some embodiments, the delay is configured by the network node. In some embodiments, the method includes pausing the second timer when an off occasion begins and resuming the second timer when the off occasion ends. In some embodiments, the method includes stopping the second timer when an off occasion begins. In some embodiments, the second timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer. In some embodiments, the method includes performing an action during an off occasion only when the action does not depend on a transmission or a reception. In some embodiments, the second duration indicates a window of time within which the WD may expect a transmission from the network node or within which the WD may transmit an uplink signal. In some embodiments, the window of time is aligned with at least one of a discontinuous reception and a paging occasion. In some embodiments, the method includes applying a first delay before triggering an action when the second timer one of starts, expires and stops during an off-occasion, and applying a second delay different from the first delay when the second timer one of starts, expires and stops during an on-occasion.

A wireless device (WD) configured to communicate with a network node is provided. The WD is configured to handle a timer in the wireless device (WD) and/or triggering an action of the wireless device (WD) associated with the timer based at least in part on a network node operating in a sleeping occasion of the network node.

According to this aspect, in some embodiments, the handling includes at least one of: starting or restarting the timer outside of the sleeping occasion by delaying a start or restart of the timer to be outside of the sleeping occasion; stopping the timer outside of the sleeping occasion by delaying the stop of the timer to be outside of the sleeping; and pausing the timer when the sleeping occasion starts and resuming the timer upon end of the sleeping occasion. In some embodiments, the triggering includes at least one of: triggering the associated action outside of the sleeping occasion when the timer has expired outside of the sleeping; triggering the associated action outside of the sleeping when the timer has expired within the sleeping occasion by delaying the triggering of the associated action to be outside of the sleeping occasion; and triggering the associated action immediately upon expiration of the timer when the associated action does not require or depending on transmission to or reception from the network node. In some embodiments, the handling includes handling the timer in a regular way irrespectively of the network node operating in the sleeping occasion and/or wherein the triggering includes triggering the associated action in a regular way irrespectively of the network node operating in the sleeping occasion. In some embodiments, the handling and/or triggering is based at least in part on the wireless device having sent a Physical Random Access Control Channel, PRACH, transmission to the network node during one of an on occasion and an off occasion of the network node or during the sleeping occasion. In some embodiments, the handling and/or triggering is based at least in part on the wireless device being aware of the network node operating in the sleeping occasion, the awareness as specified by a standard specification for the wireless device or as derived by implementation behavior of the wireless device. In some embodiments, the WD is configured to receive from the network node an indication that the network node is operating in a sleeping occasion, wherein the handling and/or triggering is performed based at least in part on the received indication. In some embodiments, the indication includes at least one of: Radio Resource Control, RRC, configuration signaling regarding handling of the timer and/or triggering the associated action; System information, SI, broadcast signaling regarding handling of the timer and/or triggering the associated action; Downlink control information, DCI, signaling regarding handling of the timer and/or triggering of the associated action; and Media Access Control, MAC, signaling regarding handling of the timer and/or triggering the associated action. In some embodiments, the handling includes using another timer and/or another timer value for the another timer when the network node is operating in the sleeping occasion. In some embodiments, the WD is configured to receive from the network node configuration information regarding the another timer and/or the another timer value. In some embodiments, the configuration information includes scaling parameters for the another timer value. In some embodiments, the another timer value is derived by the wireless device by applying predefined scaling rules with respect to a timer value of the timer. In some embodiments, the handling includes applying a first delay before triggering the associated action when the timer one of starts, expires and stops during the sleeping occasion of the network node, and applying a second delay different from the first delay when the timer one of starts, expires and stops during an on-occasion of the network node. In some embodiments, the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.

According to yet another aspect, a method implemented in a wireless device (WD) includes handling a timer in the wireless device (WD) and/or triggering an action of the wireless device (WD) associated with the timer based at least in part on a network node operating in a sleeping occasion of the network node.

According to this aspect, in some embodiments, the handling includes at least one of: starting or restarting the timer outside of the sleeping occasion by delaying a start or restart of the timer to be outside of the sleeping occasion; stopping the timer outside of the sleeping occasion by delaying the stop of the timer to be outside of the sleeping; and pausing the timer when the sleeping occasion starts and resuming the timer upon end of the sleeping occasion. In some embodiments, the triggering includes at least one of: triggering the associated action outside of the sleeping occasion when the timer has expired outside of the sleeping; triggering the associated action outside of the sleeping when the timer has expired within the sleeping occasion by delaying the triggering of the associated action to be outside of the sleeping occasion, and triggering the associated action immediately upon expiration of the timer when the associated action does not require or depending on transmission to or reception from the network node. In some embodiments, the handling includes handling the timer in a regular way irrespectively of the network node operating in the sleeping occasion and/or wherein the triggering includes triggering the associated action in a regular way irrespectively of the network node operating in the sleeping occasion. In some embodiments, one of the handling and triggering is based at least in part on the wireless device having sent a Physical Random Access Control Channel, PRACH, transmission to the network node during one of an on occasion and an off occasion of the network node or during the sleeping occasion. In some embodiments, one of the handling and triggering is based at least in part on the wireless device being aware of the network node operating in a the sleeping occasion, the awareness as specified by a standard specification for the wireless device or as derived by implementation behavior of the wireless device. In some embodiments, the method includes receiving from the network node an indication that the network node is operating in a sleeping occasion, wherein the handling and/or triggering is performed based at least in part on the received indication. In some embodiments, the indication includes at least one of: Radio Resource Control, RRC, configuration signaling regarding handling of the timer and/or triggering the associated action; System information, SI, broadcast signaling regarding handling of the timer and/or triggering the associated action; Downlink control information, DCI, signaling regarding handling of the timer and/or triggering of the associated action; and Media Access Control, MAC, signaling regarding handling of the timer and/or triggering the associated action. In some embodiments, the handling includes using another timer and/or another timer value for the another timer when the network node is operating in the sleeping occasion. In some embodiments, the method includes Receiving from the network node configuration information regarding the another timer and/or the another timer value. In some embodiments, the configuration information includes scaling parameters for the another timer value. In some embodiments, the another timer value is derived by the wireless device by applying predefined scaling rules with respect to a timer value of the timer. In some embodiments, the handling includes applying a first delay before triggering the associated action when the timer one of starts, expires and stops during the sleeping occasion of the network node, and applying a second delay different from the first delay when the timer one of starts, expires and stops during an on-occasion of the network node. In some embodiments, the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for handling wireless device (WD) timers and triggers during discontinuous reception and transmission (DTRX); and

FIG. 8 is a flowchart of an example process in a wireless device for handling wireless device (WD) timers and triggers during discontinuous reception and transmission (DTRX);

FIG. 9 is a flowchart of another example process in a network node for handling wireless device (WD) timers and triggers during discontinuous reception and transmission (DTRX);

FIG. 10 is a flowchart of another example process in a wireless device for handling wireless device (WD) timers and triggers during discontinuous reception and transmission (DTRX);

FIG. 11 is a flowchart of another example process in a network node for handling wireless device (WD) timers and triggers during discontinuous reception and transmission (DTRX); and

FIG. 12 is a flowchart of another example process in a wireless device for handling wireless device (WD) timers and triggers during discontinuous reception and transmission (DTRX)

### DETAILED DESCRIPTION

Before describing in detail example embodiments, it is noted that the embodiments reside primarily in combinations of apparatus components and processing steps related to handling wireless device (WD) timers and triggers during discontinuous reception and transmission (DTRX). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide handling wireless device (WD) timers and triggers during discontinuous reception and transmission (DTRX).

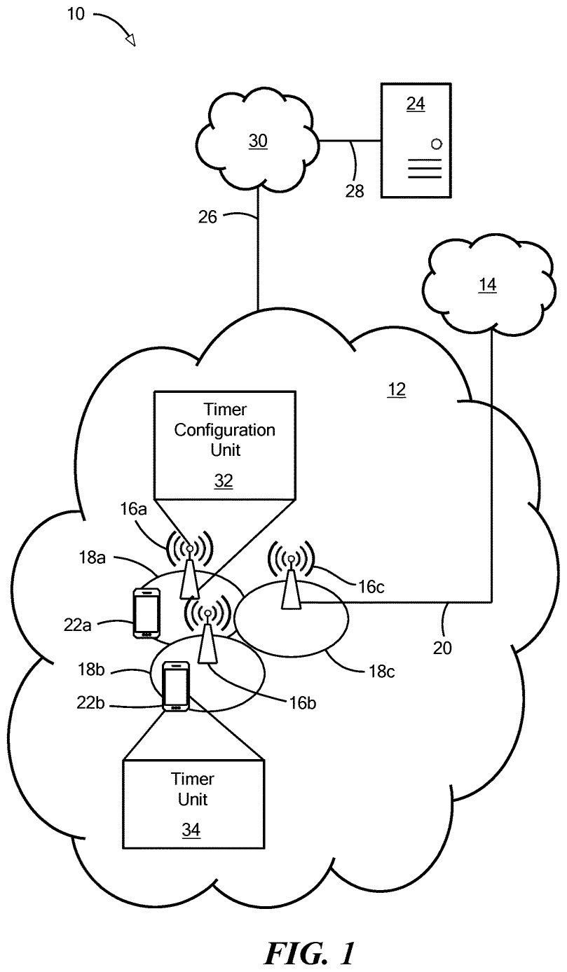

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a timer configuration unit 32 which is configured to configure the WD with a timer value for the timer, the timer value being based at least in part on whether the network node is operating with on/off occasions. Optionally, the timer configuration unit 32 may be configured to cause transmission to the wireless device 22 of an indication that the network node is operating in a sleeping occasion. A wireless device 22 is configured to include a timer unit 34 which is configured to start a timer having a duration based at least in part on the timer value, the timer value being based at least in part on whether the network node is in one of an off occasion and an on-occasion. Optionally, the timer unit 34 may also be configured to at least one of handle a timer in the WD 22 and trigger an action of the WD 22 associated with the timer based at least in part on a network node 16 operating in a sleeping occasion.

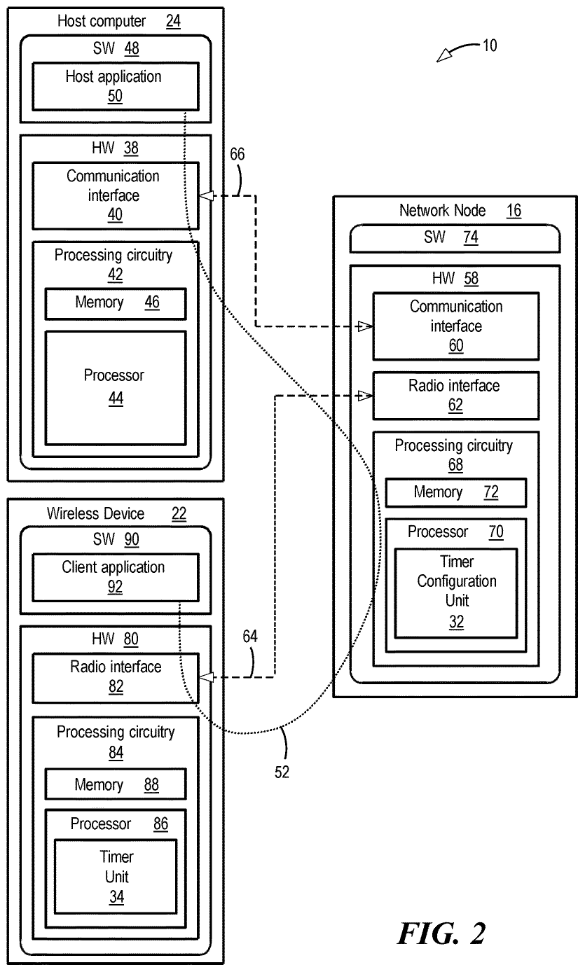

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a timer configuration unit 32 which is configured to configure the WD with a timer value for the timer, the timer value being based at least in part on whether the network node is operating with on/off occasions. Optionally, the timer configuration unit 32 may be configured to cause transmission to the wireless device 22 of an indication that the network node is operating in a sleeping occasion.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a timer unit 34 which is configured to start a timer having a duration based at least in part on the timer value, the timer value being based at least in part on whether the network node is in one of an off occasion and an on-occasion. Optionally, the timer unit 34 may also be configured to at least one of handle a timer in the WD 22 and trigger an action of the WD 22 associated with the timer based at least in part on a network node 16 operating in a sleeping occasion.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as timer configuration unit 32, and timer unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

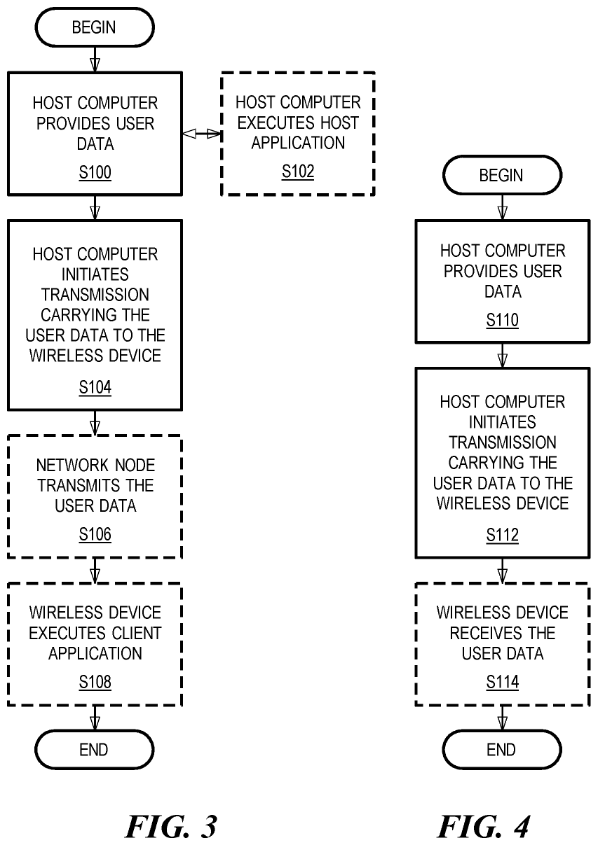

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

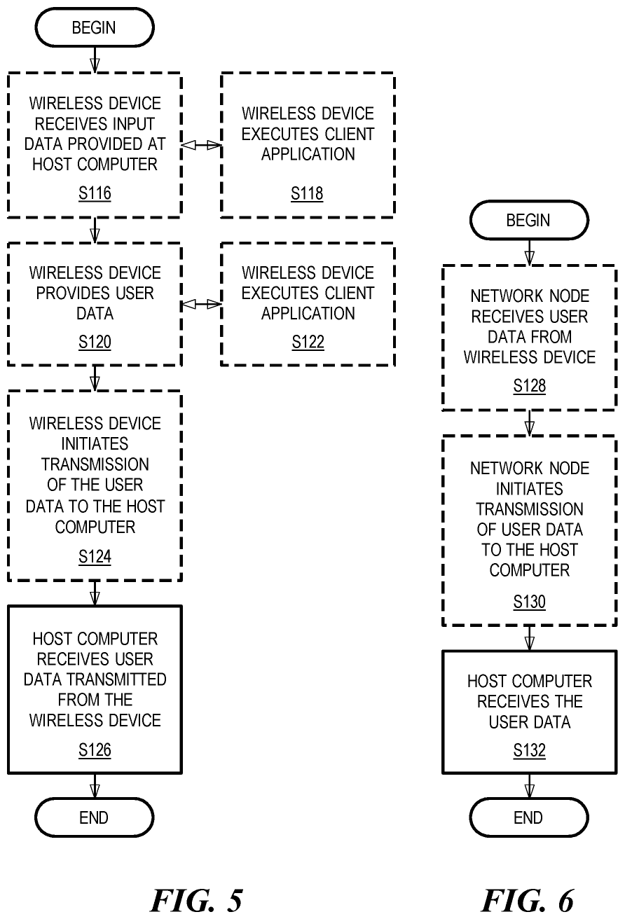

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

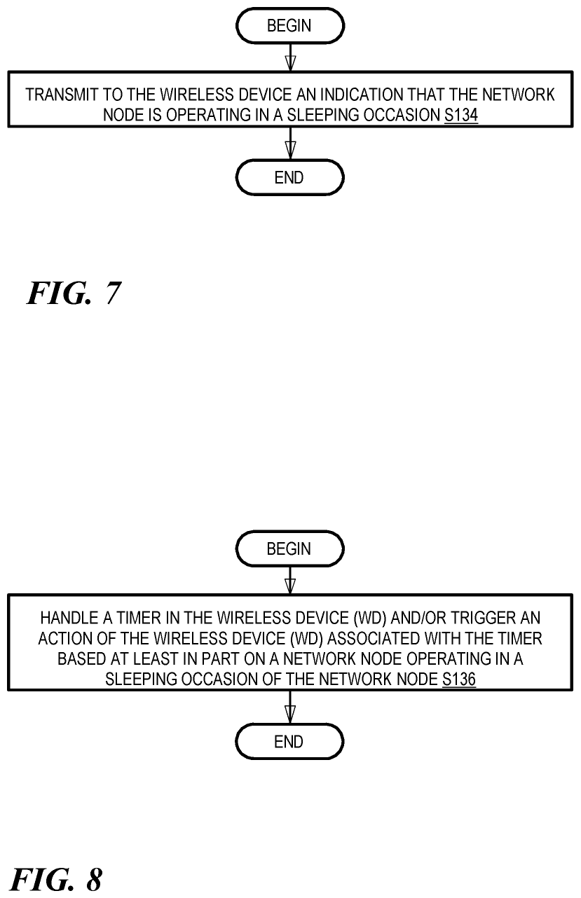

FIG. 7 is a flowchart of an example optional process in a network node 16 for handling wireless device (WD) timers and triggers during discontinuous reception and transmission (DTRX). One or more blocks described herein may be performed by one or more elements of network node 16 such as by one or more of processing circuitry 68 (including the timer configuration unit 32), processor 70, radio interface 62 and/or communication interface 60. Network node 16 such as via processing circuitry 68 and/or processor 70 and/or radio interface 62 and/or communication interface 60 is configured to transmit to the wireless device an indication that the network node 16 is operating in a sleeping occasion (Block S134).

Optionally, in some embodiments, the indication includes at least one of: Radio Resource Control, RRC, configuration signaling regarding handling of the timer and/or triggering the associated action; System information, SI, broadcast signaling regarding handling of the timer and/or triggering the associated action; Downlink control information, DCI, signaling regarding handling of the timer and/or triggering the associated action, and Media Access Control, MAC, signaling regarding handling of the timer and/or triggering the associated action. In some embodiments, the network node 16 is configured to transmit to the wireless device configuration information regarding another timer and/or the another timer value to be used during the sleeping occasion of the network node 16. In some embodiments, the configuration information includes scaling parameters for the another timer value. In some embodiments, the network node 16 is configured to transmit to the wireless device an instruction to suspend handling of a timer in the wireless device and a further instruction to resume handling of the timer.

FIG. 8 is a flowchart of an example optional process in a wireless device 22 according to some embodiments of the present disclosure. One or more blocks described herein may be performed by one or more elements of wireless device 22 such as by one or more of processing circuitry 84 (including the timer unit 34), processor 86, radio interface 82 and/or communication interface 60. Wireless device 22 such as via processing circuitry 84 and/or processor 86 and/or radio interface 82 is configured to handle a timer in the wireless device (WD) 22 and/or trigger an action of the wireless device (WD) 22 associated with the timer based at least in part on a network node 16 operating in a sleeping occasion (Block S136).

Optionally, in some embodiments, the handling includes at least one of: starting or restarting the timer outside of the sleeping occasion by delaying a start or restart of the timer to be outside of the sleeping occasion; stopping the timer outside of the sleeping occasion by delaying the stop of the timer to be outside of the sleeping; and pausing the timer when the sleeping occasion starts and resuming the timer upon end of the sleeping occasion. In some embodiments, the triggering includes at least one of: triggering the associated action outside of the sleeping occasion when the timer has expired outside of the sleeping; triggering the associated action outside of the sleeping when the timer has expired within the sleeping occasion by delaying the triggering of the associated action to be outside of the sleeping occasion, and triggering the associated action immediately upon expiration of the timer when the associated action does not require or depending on transmission to or reception from the network node 16. In some embodiments, the handling includes handling the timer in a regular way irrespectively of the network node 16 operating in the sleeping occasion and/or wherein the triggering includes triggering the associated action in a regular way irrespectively of the network node 16 operating in the sleeping occasion. In some embodiments, the handling and/or triggering is based at least in part on the wireless device having sent a Physical Random Access Control Channel, PRACH, transmission to the network node 16 during an on occasion or an off occasion of the network node 16 or during the sleeping occasion. In some embodiments, the handling and/or triggering is based at least in part on the wireless device being aware of the network node 16 operating in a the sleeping occasion, the awareness as specified by a standard specification for the wireless device or as derived by implementation behavior of the wireless device. In some embodiments, the method includes receiving from the network node 16 an indication that the network node 16 is operating in a sleeping occasion, wherein the handling and/or triggering is performed based at least in part on the received indication. In some embodiments, the indication includes at least one of: Radio Resource Control, RRC, configuration signaling regarding handling of the timer and/or triggering the associated action; System information, SI, broadcast signaling regarding handling of the timer and/or triggering the associated action; Downlink control information, DCI, signaling regarding handling of the timer and/or triggering of the associated action; and Media Access Control, MAC, signaling regarding handling of the timer and/or triggering the associated action. In some embodiments, the handling includes using another timer and/or another timer value for the another timer when the network node 16 is operating in the sleeping occasion. In some embodiments, the method includes receiving from the network node 16 configuration information regarding the another timer and/or the another timer value. In some embodiments, the configuration information includes scaling parameters for the another timer value. In some embodiments, the another timer value is derived by the wireless device by applying predefined scaling rules with respect to a timer value of the timer. In some embodiments, the handling includes applying a first delay before triggering the associated action when the timer one of starts, expires and stops during the sleeping occasion of the network node 16, and applying a second delay different from the first delay when the timer one of starts, expires and stops during an on-occasion of the network node 16. In some embodiments, the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.

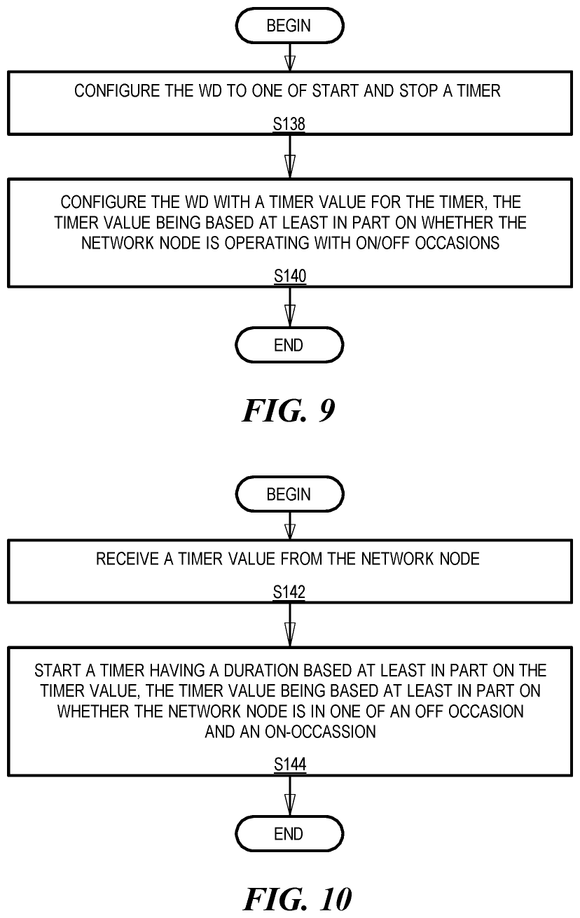

FIG. 9 is a flowchart of an example process in a network node 16 for handling wireless device (WD) timers and triggers during discontinuous reception and transmission (DTRX). One or more blocks described herein may be performed by one or more elements of network node 16 such as by one or more of processing circuitry 68 (including the timer configuration unit 32), processor 70, radio interface 62 and/or communication interface 60. Network node 16 such as via processing circuitry 68 and/or processor 70 and/or radio interface 62 and/or communication interface 60 is configured to configure the WD 22 to one of start and stop a timer (Block S138). The process also includes configuring the WD 22 with a timer value for the timer, the timer value being based at least in part on whether the network node 16 is operating with on/off occasions (Block S140).

In some embodiments, the timer value is a first timer value when the WD 22 operates according to a first wireless communication standard and is a second timer value different from the first timer value when the WD 22 operates according to a second wireless communication standard, the first wireless communication standard not supporting on/off occasions and the second wireless communication standard supporting on/off occasions. In some embodiments, configuring the WD 22 with a timer value includes configuring the WD 22 with a scaling parameter to be used by the WD 22 when the network node 16 is operating with on/off occasions. In some embodiments, the method also includes determining the scaling parameter based at least in part on a length of a discontinuous transmission and reception, DTRX, cycle. In some embodiments, the method also includes signaling a sleep occasion to the WD 22.

FIG. 10 is a flowchart of an example process in a wireless device 22 according to some embodiments of the present disclosure. One or more blocks described herein may be performed by one or more elements of wireless device 22 such as by one or more of processing circuitry 84 (including the timer unit 34), processor 86, radio interface 82 and/or communication interface 60. Wireless device 22 such as via processing circuitry 84 and/or processor 86 and/or radio interface 82 is configured to receive a timer value from the network node 16 (Block S142). The processor also includes starting a timer having a duration based at least in part on the timer value, the timer value being based at least in part on whether the network node 16 is in one of an off occasion and an on-occasion (Block S144).

In some embodiments, the method also includes delaying start of the timer according to a pre-configured delay. In some embodiments, the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer. In some embodiments, the method also includes triggering an action upon expiry of the timer when the expiry of the timer occurs outside an off-occasion. In some embodiments, the method also includes performing an action upon expiry of the timer when the action does not depend on a transmission or a reception. In some embodiments, the method also includes stopping the timer when the network node 16 is in an off occasion. In some embodiments, the method also includes pausing the timer when an off occasion starts. In some embodiments, the timer value includes a scaling parameter. In some embodiments, the method also includes applying a first delay before triggering an action when the timer one of starts, expires and stops during an off-occasion, and applying a second delay different from the first delay when the timer one of starts, expires and stops during an on-occasion.

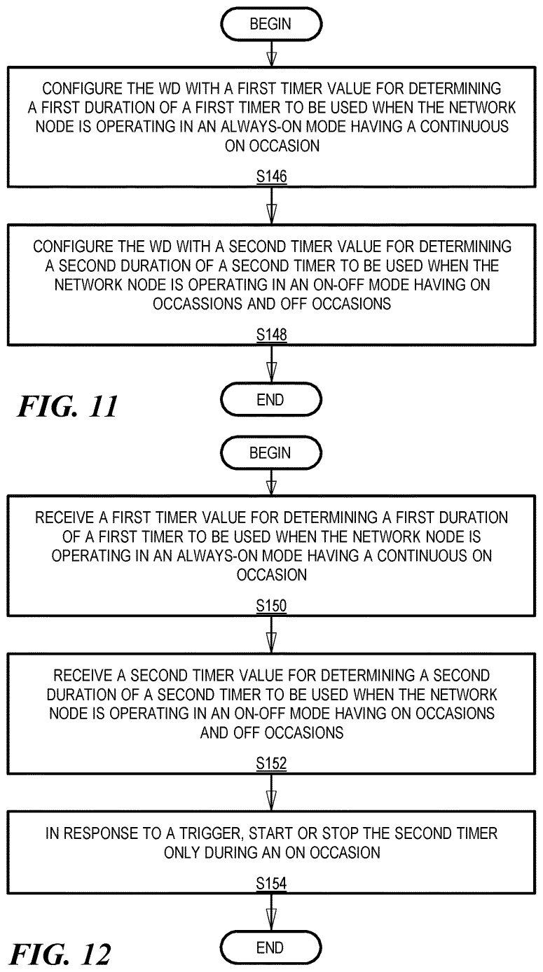

FIG. 11 is a flowchart of an example optional process in a network node 16 for handling wireless device (WD 22) timers and triggers during discontinuous reception and transmission (DTRX). One or more blocks described herein may be performed by one or more elements of network node 16 such as by one or more of processing circuitry 68 (including the timer configuration unit 32), processor 70, radio interface 62 and/or communication interface 60. Network node 16 such as via processing circuitry 68 and/or processor 70 and/or radio interface 62 and/or communication interface 60 is configured to configure the WD 22 with a first timer value for determining a first duration of a first timer to be used when the network node 16 is operating in an always-on mode having a continuous on occasion (Block 146). The process includes configuring the WD 22 with a second timer value for determining a second duration of a second timer to be used when the network node 16 is operating in an on-off mode having on occasions and off occasions (Block 148)

Optionally, in some embodiments, the second duration is a duration between a start time and a stop time of the second timer, respectively. In some embodiments, the second timer value is a scaling factor from which the WD 22 determines the second duration. In some embodiments, the scaling factor is based at least in part on a length of a discontinuous transmission and reception, DTRX, cycle. In some embodiments, the first timer is associated with WD 22 operation according to a first wireless access communication standard and the second timer is associated with WD operation according to a second wireless communication standard. In some embodiments, the method includes transmitting to the WD 22 an indication of a sleep pattern of the network node 16. In some embodiments, at least one of the first and second timers is a duration timer, an inactivity timer, a discontinuous transmission and reception, DTRX, cycle, a reference signal transmission timer, a physical random access channel, PRACH, occasion timer, an uplink or downlink reception or transmission timer, and a measurement window timer. In some embodiments, at least one of the first and second timers is a duration timer indicating a window of time within which the WD 22 may expect a transmission from the network node 16 or within which the WD 22 may transmit an uplink signal. In some embodiments, the window of time is aligned with at least one of a discontinuous reception and a paging occasion. In some embodiments, at least one of the first and second timers is one of a radio resource control, RRC, timer and a predefined timer.

FIG. 12 is a flowchart of an example optional process in a wireless device 22 according to some embodiments of the present disclosure. One or more blocks described herein may be performed by one or more elements of wireless device 22 such as by one or more of processing circuitry 84 (including the timer unit 34), processor 86, radio interface 82 and/or communication interface 60. Wireless device 22 such as via processing circuitry 84 and/or processor 86 and/or radio interface 82 is configured to receive a first timer value for determining a first duration of a first timer to be used when the network node 16 is operating in an always-on mode having a continuous on occasion (Block S150). The process includes receiving a second timer value for determining a second duration of a second timer to be used when the network node 16 is operating in an on-off mode having on occasions and off occasions (Block S152). The process also includes in response to a trigger, starting or stopping the second timer only during an on occasion (Block S154).

Optionally, in some embodiments, when the trigger is received during an off occasion, starting or stopping the second timer is postponed until an end of the off occasion. In some embodiments, the method includes, when the second timer expires during an off occasion, postponing performance of an action to be performed at an expiry of the second timer until a next on occasion. In some embodiments, the method includes, when the second timer expires during an off occasion, postponing performance of an action to be performed at an expiry of the second timer until after a period of delay. In some embodiments, the delay is configured by the network node 16. In some embodiments, the method includes pausing the second timer when an off occasion begins and resuming the second timer when the off occasion ends. In some embodiments, the method includes stopping the second timer when an off occasion begins. In some embodiments, the second timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer. In some embodiments, the method includes performing an action during an off occasion only when the action does not depend on a transmission or a reception. In some embodiments, the second duration indicates a window of time within which the WD 22 may expect a transmission from the network node 16 or within which the WD 22 may transmit an uplink signal. In some embodiments, the window of time is aligned with at least one of a discontinuous reception and a paging occasion. In some embodiments, the method includes applying a first delay before triggering an action when the second timer one of starts, expires and stops during an off-occasion, and applying a second delay different from the first delay when the second timer one of starts, expires and stops during an on-occasion.

Having described the general process flow of arrangements of the disclosure and having provided examples of hardware and software arrangements for implementing the processes and functions of the disclosure, the sections below provide details and examples of arrangements for handling wireless device (WD 22) timers and triggers during discontinuous reception and transmission (DTRX).

Sleeping occasion(s) are occasions where transmission and reception are reduced or not expected at all (due to network sleeping pattern for energy saving). Hence, they may be applicable to multiple network node sleep states (e.g., light sleep, or a cell that is completely off).

An occasion (e.g., symbols/slots/frames/etc.) may be indicated as an off occasion or as an on occasion based on signaling (e.g., Off/On signaling) from a network node 16. Some occasions (e.g., pre-determined or configured) may be considered an “on-occasion”—for example, these may be symbols where an SSB is transmitted. During an “off-occasion”, network node transmission and reception of signals or channels is not expected. A WD 22 may expect that a network node 16 may transmit and receive signals or channels during an on-occasion. In certain embodiments, during an off-occasion, network node transmission and reception of signals or channels is expected with relatively reduced settings (e.g., sparse in time and frequency) relative to an on-occasion. In some cases, the WD 22 is not allowed to transmit (and/or receive) during an off-occasion. In some cases, an off-occasion may be defined for both downlink and uplink, downlink only, or uplink only. The off-occasions may be indicated using a downlink control information (DCI) message or medium access control (MAC) control element (CE) or radio resource control (RRC) signaling.

A timer may be any of the following non-limiting examples:
1. such timers include a duration timer, an inactivity timer, a DTRX cycle, a reference signal (RS) transmission timer, a physical random access channel (PRACH) occasion timers, UL/DL reception and transmission timers, or measurement windows timers;
2. In one example, an on duration timer is the time window within which the WD 22 may expect a transmission from the network node 16, or may transmit an UL signal. On duration timers may be aligned with WD C-DRX or paging occasion (PO) or not. Furthermore, the WD 22 may be configured with a wake-up signal (WUS) mechanism such that it may indicate to the network node 16 before or in the beginning of the ON duration that the network node 16 should be ON during one or more of the upcoming ON durations;
3. An inactivity timer may be a timer which is triggered, e.g., by an on-going transmission of data or WD requested signals or reference signals (RSs), and so on from the network node 16 to the WD 22, or by reception of a signal from the WD 22, e.g., an UL request, etc.;
4. The DTRX cycle, may be the cycle which begins from the current on duration timer until the next on duration timer;
5. Timers may be one or more of RRC timers such as T311 or any of the timers as defined in 3GPP TS 38.331, e.g. V17.2.0 (2022-09), section 7.1; and/or
6. Timers may also be indirectly based on time windows (e.g., medium access control (MAC) random access (RA) response window).

### Detailed Description of WD Aspects

The WD handling of various timers involved in various procedures may change according to off-occasions where transmissions and receptions are not expected (e.g., due to network sleeping pattern for energy saving) by any of following:

### Start or Re-Start of a Timer:

A timer may be started (or re-started) only outside the off-occasions. If the start is to be triggered while in one of the off-occasions, the WD 22 may delay the start of the timer until the off-occasion is over (i.e., transmissions and/or receptions are resumed or until the next on-occasion). In another example, if the start is to be triggered while in one of the off-occasions, the WD 22 may delay the start of the timer wherein the delay may be explicitly indicated by the network node 16 via higher layer signaling such as MAC-control element (CE), RRC signaling. Such timers may include WD C-DRX on-duration timer and inactivity timer, DRX cycle, RS transmission timer, PRACH occasion timers, UL/DL reception and transmission timers, or measurement windows timers;

### Timer Expiry:

Upon timer expiration, the WD 22 may only trigger the corresponding actions if the timer expired outside the off-occasions. If the timer expires while in one of the off-occasions, the WD 22 delays the corresponding actions until the off-occasions is over or with a delay. The delay may be explicitly indicated by the network node 16 via higher layer signaling such as MAC-CE, RRC signaling or until the next on-occasion. Such actions may include any that require transmission and reception of signals or channels from the network node 16.

In some embodiments, the WD 22 may perform the corresponding actions upon timer expiration if they do not require or depend on any transmission or reception, e.g., release of a certain configuration or start/re-start of other timers;

### Timer Stop:

A timer may be stopped only outside the off-occasions. If the stop is to be triggered while in one of the off-occasions, the WD 22 may delay the stop of the timer until the off-occasion is over (i.e., transmissions and/or receptions are resumed) or with a delay. The delay may be explicitly indicated by the network node 16 via higher layer signaling such as MAC-CE, RRC signaling or until the next on-occasion;

### Timer Pause-Resume:

A timer that is running may be paused when an off-occasion starts and resumed upon the end of the sleeping occasion. Such pause-resume action may be applied to timers that may need transmission and reception of signals or channels from the network node 16 (e.g., random access response, DRX DL/UL retransmission timer, etc.); The WD handling of various timers as described above may be controlled by any of following non-limiting examples:
Higher layer signaling, e.g., RRC configuration or system information (SI) broadcast;
   The WD 22 may be configured with different behaviors for each timer or a group of timers; and/or
   Alternatively, if for one or a group of timers, a specific configuration if not provided, a default value or default pre-configuration is relevant; and/or
Controlled behavior via L1/L2 signaling, such as MAC CE/downlink control information (DCI);
Implicitly handled based on the WD awareness of network node sleeping occasions or off-occasions (e.g., specified in 3GPP TS 38.331 or left up to WD implementation);
For some timers (e.g., DRX on duration timer, etc.), the timer behavior may be unaffected by the off-occasions (and on-occasions), i.e., the WD 22 applies timer behavior as in the legacy case; and/or
Implicitly based on WD actions, e.g., an UL request or physical random access channel (PRACH) transmission during on-occasions. It may be specified, e.g., that whenever the WD 22 triggers this procedure, the network node 16 may assume the WD 22 is handling timers as specified, for example, in Section 7.1.1 in 3GPP TS 38.331, e.g. V17.2.0 (2022-09); otherwise, the WD 22 may handle timers according to any of the solutions above.

In some embodiments, a different set of network node configured timers are used while the network node 16 is operating with on/off occasions. The values of the second set of timers are either explicitly configured or derived by the WD 22 based on scaling parameters configured by the network node 16 or predefined scaling rules depending on network node on/off occasions; and/or

In some embodiments, a WD 22 acquires configuration information, the information configuring the WD 22 to monitor and/or receive signaling of on/off occasions. For at least one timer, the WD action associated with the timer that a WD 22 applies may be based on whether the start/expiry/stop occurs during an off-occasion or during an on-occasion. If the start/expiry/stop occurs during an off-occasion, the WD 22 may apply the associated actions with a first delay value. If the start/expiry/stop occurs during an on occasion or off-occasion, the WD 22 may apply the associated actions with a second delay value, wherein the second delay value is different, e.g. smaller, than the first delay value. In certain embodiments, the second delay value is 0. In certain embodiments, the first delay value is determined based on the end of the off-occasion(s).

Thus, in some embodiments, the WD 22 is optionally configured to handle a timer in the WD 22 and/or trigger an action of the WD 22 associated with the timer based at least in part on a network node 16 operating in a sleeping occasion of the network node 16. In some embodiments, the handling includes at least one of: starting or restarting the timer outside of the sleeping occasion by delaying a start or restart of the timer to be outside of the sleeping occasion; stopping the timer outside of the sleeping occasion by delaying the stop of the timer to be outside of the sleeping; and pausing the timer when the sleeping occasion starts and resuming the timer upon end of the sleeping occasion. In some embodiments, the triggering includes at least one of: triggering the associated action outside of the sleeping occasion when the timer has expired outside of the sleeping; triggering the associated action outside of the sleeping when the timer has expired within the sleeping occasion by delaying the triggering of the associated action to be outside of the sleeping occasion; and triggering the associated action immediately upon expiration of the timer when the associated action does not require or depending on transmission to or reception from the network node 16. In some embodiments, the handling includes handling the timer in a regular way irrespectively of the network node 16 operating in the sleeping occasion and/or wherein the triggering includes triggering the associated action in a regular way irrespectively of the network node 16 operating in the sleeping occasion. In some embodiments, the handling and/or triggering is based at least in part on the wireless device having sent a Physical Random Access Control Channel, PRACH, transmission to the network node 16 during one of an on occasion and an off occasion of the network node 16 or during the sleeping occasion. In some embodiments, the handling and/or triggering is based at least in part on the wireless device being aware of the network node 16 operating in a the sleeping occasion, the awareness as specified by a standard specification for the wireless device or as derived by implementation behavior of the wireless device. In some embodiments, the WD 22 is configured to receive from the network node 16 an indication that the network node 16 is operating in a sleeping occasion, wherein the handling and/or triggering is performed based at least in part on the received indication. In some embodiments, the indication includes at least one of: Radio Resource Control, RRC, configuration signaling regarding handling of the timer and/or triggering the associated action; System information, SI, broadcast signaling regarding handling of the timer and/or triggering the associated action; Downlink control information, DCI, signaling regarding handling of the timer and/or triggering of the associated action; and Media Access Control, MAC, signaling regarding handling of the timer and/or triggering the associated action. In some embodiments, the handling includes using another timer and/or another timer value for the another timer when the network node 16 is operating in the sleeping occasion. In some embodiments, the WD 22 is configured to receive from the network node 16 configuration information regarding the another timer and/or the another timer value. In some embodiments, the configuration information includes scaling parameters for the another timer value. In some embodiments, the another timer value is derived by the wireless device by applying predefined scaling rules with respect to a timer value of the timer. In some embodiments, the handling includes applying a first delay before triggering the associated action when the timer one of starts, expires and stops during the sleeping occasion of the network node 16, and applying a second delay different from the first delay when the timer one of starts, expires and stops during an on-occasion of the network node 16. In some embodiments, the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.

### Detailed Description of Network Node Aspects

In some embodiments, the WD 22 side handling may be different according to the service, or other facts. The WD 22 may apply the complete “DTRX timer” handling according to the above, or only handle some of the “timers” in this way, and others in a legacy way.

In some embodiments, the NG-RAN node indicates to the WD 22 to start/stop the “DTRX timer” handling as mentioned above. Optionally, in some embodiments, when a WD 22 is using a timer, some other timers may be configured by the network node 16 by RRC. In some embodiments, some other timers may be hardcoded at the WD 22.

In some embodiments, the NG-RAN node may control when the WD 22 uses the above “DTRX timer” handling via configuration or predefined rules, for example, based on 5QI, and traffic characteristics. Accordingly, the network cells may not be totally “switched off”, but rather, are capable of handling urgent transmission. The network may decide this upon the WDs and services that it currently serving. In some embodiments, the “sleep occasion” is not signaled to WD 22. WD 22 is instructed to suspend the handling of the timer, and later is instructed to resume the handling.

In some embodiments, the network node 16 configures two set of values for one or more timers, one of which is applicable to when the network node 16 is always on (legacy values), while the other is applicable in case the network node 16 is operating with “on/off occasions”. As such the WD 22 behaves as in legacy procedures but uses different timer values depending on network node operation mode. In some embodiments, instead of a second set of values, the network node 16 provides timer scaling parameters. While the network node 16 is operating with “on/off occasions”, the scaled version of the timer values is applicable. Through such scaling, the network node 16 may adapt the timer length to the “on/off occasions” it is operating in (e.g., larger scaling factors while in long DTRX cycles, and shorter scaling factors while in short DTRX cycles).

Thus, optionally, in some embodiments, a network node 16 is configured to transmit to the wireless device an indication that the network node 16 is operating in a sleeping occasion. In some embodiments, the indication includes at least one of: Radio Resource Control, RRC, configuration signaling regarding handling of the timer and/or triggering the associated action; System information, SI, broadcast signaling regarding handling of the timer and/or triggering the associated action; Downlink control information, DCI, signaling regarding handling of the timer and/or triggering the associated action, and Media Access Control, MAC, signaling regarding handling of the timer and/or triggering the associated action. In some embodiments, the network node 16 is configured to transmit to the wireless device configuration information regarding another timer and/or the another timer value to be used during the sleeping occasion of the network node 16. In some embodiments, the configuration information includes scaling parameters for the another timer value. In some embodiments, the network node 16 is configured to transmit to the wireless device an instruction to suspend handling of a timer in the wireless device and a further instruction to resume handling of the timer.

Some embodiments may include one or more of the following:
Embodiment A1. A network node configured to communicate with a wireless device (WD), the network node configured to, and/or comprising a radio interface and/or comprising processing circuitry configured to:
configure the WD to one of start and stop a timer; and
configure the WD with a timer value for the timer, the timer value being based at least in part on whether the network node is operating with on/off occasions.
Embodiment A2. The network node of Embodiment A1, wherein the timer value is a first timer value when the WD operates according to a first wireless communication standard and is a second timer value different from the first timer value when the WD operates according to a second wireless communication standard, the first wireless communication standard not supporting on/off occasions and the second wireless communication standard supporting on/off occasions.
Embodiment A3. The network node of any of Embodiments A1 and A2, wherein configuring the WD with a timer value includes configuring the WD with a scaling parameter to be used by the WD when the network node is operating with on/off occasions.
Embodiment A4. The network node of Embodiment A3, wherein the network node, radio interface and/or processing circuitry are further configured to determine the scaling parameter based at least in part on a length of a DTRX cycle.
Embodiment A5. The network node of any of Embodiments A1-A4, wherein the network node, radio interface and/or processing circuitry are further configured to signal a sleep occasion to the WD.
Embodiment B1. A method implemented in a network node configured to communicate with a wireless device, WD, the method comprising:
configuring the WD to one of start and stop a timer; and
configuring the WD with a timer value for the timer, the timer value being based at least in part on whether the network node is operating with on/off occasions.
Embodiment B2. The method of Embodiment B1, wherein the timer value is a first timer value when the WD operates according to a first wireless communication standard and is a second timer value different from the first timer value when the WD operates according to a second wireless communication standard, the first wireless communication standard not supporting on/off occasions and the second wireless communication standard supporting on/off occasions.
Embodiment B3. The method of any of Embodiments B1 and B2, wherein configuring the WD with a timer value includes configuring the WD with a scaling parameter to be used by the WD when the network node is operating with on/off occasions.
Embodiment B4. The method of Embodiment B3, further comprising determining the scaling parameter based at least in part on a length of a discontinuous transmission and reception, DTRX, cycle.
Embodiment B5. The method of any of Embodiments B1-B4, further comprising signaling a sleep occasion to the WD.
Embodiment C1. A wireless device (WD) configured to communicate with a network node, the WD configured to, and/or comprising a radio interface and/or processing circuitry configured to:
receive a timer value from the network node; and
start a timer having a duration based at least in part on the timer value, the timer value being based at least in part on whether the network node is in one of an off occasion and an on-occasion.
Embodiment C2. The WD of Embodiment C1, wherein the WD, radio interface and/or processing circuitry are configured to delay start of the timer according to a pre-configured delay.
Embodiment C3. The WD of any of Embodiments C1 and C2, wherein the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.
Embodiment C4. The WD of any of Embodiments C1-C3, wherein the WD, radio interface and/or processing circuitry are configured to trigger an action upon expiry of the timer when the expiry of the timer occurs outside an off-occasion.
Embodiment C5. The WD of any of Embodiments C1-C3, wherein the WD, radio interface and/or processing circuitry are further configured to perform an action upon expiry of the timer when the action does not depend on a transmission or a reception.
Embodiment C6. The WD of any of Embodiments C1-C5, wherein the WD, radio interface and/or processing circuitry are further configured to stop the timer when the network node is in an off occasion.
Embodiment C7. The WD of any of Embodiments C1-C6, wherein the WD, radio interface and/or processing circuitry are further configured to pause the timer when an off occasion starts.
Embodiment C8. The WD of any of Embodiments C1-C7, wherein the timer value includes a scaling parameter.
Embodiment C9. The WD of any of Embodiments C1-C8, wherein the WD, radio interface and/or processing circuitry are configured to apply a first delay before triggering an action when the timer one of starts, expires and stops during an off-occasion, and to apply a second delay different from the first delay when the timer one of starts, expires and stops during an on-occasion.
Embodiment D1. A method implemented in a wireless device (WD), the method comprising:
receiving a timer value from the network node; and
starting a timer having a duration based at least in part on the timer value, the timer value being based at least in part on whether the network node is in one of an off occasion and an on-occasion.
Embodiment D2. The method of Embodiment D1, further comprising delaying start of the timer according to a pre-configured delay.
Embodiment D3. The method of any of Embodiments D1 and D2, wherein the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.
Embodiment D4. The method of any of Embodiments D1-D3, further comprising triggering an action upon expiry of the timer when the expiry of the timer occurs outside an off-occasion.
Embodiment D5. The method of any of Embodiments D1-D3, further comprising performing an action upon expiry of the timer when the action does not depend on a transmission or a reception.
Embodiment D6. The method of any of Embodiments D1-D5, further comprising stopping the timer when the network node is in an off occasion.
Embodiment D7. The method of any of Embodiments D1-D6, further comprising pausing the timer when an off occasion starts.
Embodiment D8. The method of any of Embodiments D1-D7, wherein the timer value includes a scaling parameter.
Embodiment D9. The method of any of Embodiments D1-D8, further comprising applying a first delay before triggering an action when the timer one of starts, expires and stops during an off-occasion, and applying a second delay different from the first delay when the timer one of starts, expires and stops during an on-occasion.

Some embodiments may include one or more of the following:
1. A network node configured to communicate with a wireless device, WD, the network node configured to:
configure the WD with a first timer value for determining a first duration of a first timer to be used when the network node (16) is operating in an always-on mode having a continuous on occasion; and
configure the WD with a second timer value for determining a second duration of a second timer to be used when the network node (16) is operating in an on-off mode having on occasions and off occasions.
2. The network node of Embodiment 1, wherein the second duration is a duration between a start time and a stop time of the second timer, respectively.
3. The network node of Embodiment 1, wherein the second timer value is a scaling factor from which the WD determines the second duration.
4. The network node of Embodiment 3, wherein the scaling factor is based at least in part on a length of a discontinuous transmission and reception, DTRX, cycle.
5. The network node (16) of any of Embodiments 1-4, wherein the first timer is associated with WD operation according to a first wireless access communication standard and the second timer is associated with WD operation according to a second wireless communication standard.
6. The network node of any of Embodiments 1-5, wherein the network node is configured to transmit to the WD an indication of a sleep pattern of the network node.
7. The network node of any of Embodiments 1-6, wherein at least one of the first and second timers is a duration timer, an inactivity timer, a discontinuous transmission and reception, DTRX, cycle, a reference signal transmission timer, a physical random access channel, PRACH, occasion timer, an uplink or downlink reception or transmission timer, and a measurement window timer.
8. The network node of any of Embodiments 1-6, wherein at least one of the first and second timers is a duration timer indicating a window of time within which the WD may expect a transmission from the network node (16) or within which the WD may transmit an uplink signal.
9 The network node of Embodiment 8, wherein the window of time is aligned with at least one of a discontinuous reception and a paging occasion.
10. The network node of any of Embodiments 1-9, wherein at least one of the first and second timers is one of a radio resource control, RRC, timer and a predefined timer.
11. A method in a network node configured to communicate with a wireless device, WD, the method comprising:
configuring the WD with a first timer value for determining a first duration of a first timer to be used when the network node is operating in an always-on mode having a continuous on occasion; and
configuring the WD with a second timer value for determining a second duration of a second timer to be used when the network node is operating in an on-off mode having on occasions and off occasions.
12. The method of Embodiment 11, wherein the second duration is a duration between a start time and a stop time of the second timer, respectively.
13. The method of Embodiment 11, wherein the second timer value is a scaling factor from which the WD determines the second duration.
14. The method of Embodiment 13, wherein the scaling factor is based at least in part on a length of a discontinuous transmission and reception, DTRX, cycle.
15. The method of any of Embodiments 11-14, wherein the first timer is associated with WD operation according to a first wireless access communication standard and the second timer is associated with WD operation according to a second wireless communication standard.
16. The method of any of Embodiments 11-15, further including transmitting to the WD an indication of a sleep pattern of the network node (16).
17. The method of any of Embodiments 11-16, wherein at least one of the first and second timers is a duration timer, an inactivity timer, a discontinuous transmission and reception, DTRX, cycle, a reference signal transmission timer, a physical random access channel, PRACH, occasion timer, an uplink or downlink reception or transmission timer, and a measurement window timer.
18. The method of any of Embodiments 11-16, wherein at least one of the first and second timers is a duration timer indicating a window of time within which the WD may expect a transmission from the network node (16) or within which the WD may transmit an uplink signal.
19. The method of Embodiment 18, wherein the window of time is aligned with at least one of a discontinuous reception and a paging occasion.
20. The method of any of Embodiments 11-19, wherein at least one of the first and second timers is one of a radio resource control, RRC, timer and a predefined timer.
31. A wireless device WD configured to communicate with a network node, the WD configured to:
receive a first timer value for determining a first duration of a first timer to be used when the network node is operating in an always-on mode having a continuous on occasion;
receive a second timer value for determining a second duration of a second timer to be used when the network node is operating in an on-off mode having on occasions and off occasions; and
in response to a trigger, start or stop the second timer only during an on occasion.
32. The WD of Embodiment 31, wherein, when the trigger is received during an off occasion, starting or stopping the second timer is postponed until an end of the off occasion.
33. The WD of any of Embodiments 31 and 32, wherein the WD is configured to, when the second timer expires during an off occasion, postpone performance of an action to be performed at an expiry of the second timer until a next on occasion.
34. The WD of any of Embodiments 31 and 32, wherein the WD is configured to, when the second timer expires during an off occasion, postpone performance of an action to be performed at an expiry of the second timer until after a period of delay.
35. The WD of Embodiment 34, wherein the delay is configured by the network node (16).
36. The WD of any of Embodiments 31-35, wherein the WD is configured to pause the second timer when an off occasion begins and resume the second timer when the off occasion ends.
37. The WD of any of Embodiments 31-36, wherein the WD is configured to stop the second timer when an off occasion begins.
38. The WD of any of Embodiments 31-37, wherein the second timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.
39. The WD of any of Embodiments 31-38, wherein the WD is configured to perform an action during an off occasion only when the action does not depend on a transmission or a reception.
40. The WD of any of Embodiments 31-39, wherein the second duration indicates a window of time within which the WD may expect a transmission from the network node or within which the WD may transmit an uplink signal.
41. The WD of Embodiment 40, wherein the window of time is aligned with at least one of a discontinuous reception and a paging occasion.
42. The WD of any of Embodiments 31-41, wherein the WD is configured to apply a first delay before triggering an action when the second timer one of starts, expires and stops during an off-occasion, and to apply a second delay different from the first delay when the second timer one of starts, expires and stops during an on-occasion.
43. A method in a wireless device, WD, configured to communicate with a network node, the method comprising:
receiving a first timer value for determining a first duration of a first timer to be used when the network node is operating in an always-on mode having a continuous on occasion;
receiving a second timer value for determining a second duration of a second timer to be used when the network node is operating in an on-off mode having on occasions and off occasions; and
in response to a trigger, starting or stopping the second timer only during an on occasion.
44. The method of Embodiment 43, wherein, when the trigger is received during an off occasion, starting or stopping the second timer is postponed until an end of the off occasion.
45. The method of any of Embodiments 43 and 44, further comprising, when the second timer expires during an off occasion, postponing performance of an action to be performed at an expiry of the second timer until a next on occasion.
46. The method of any of Embodiments 43 and 44, further comprising, when the second timer expires during an off occasion, postponing performance of an action to be performed at an expiry of the second timer until after a period of delay.
47. The method of Embodiment 46, wherein the delay is configured by the network node.
48. The method of any of Embodiments 43-47, further comprising pausing the second timer when an off occasion begins and resuming the second timer when the off occasion ends.
49. The method of any of Embodiments 43-48, further comprising stopping the second timer when an off occasion begins.
50. The method of any of Embodiments 43-49, wherein the second timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.
51. The method of any of Embodiments 43-50, further comprising performing an action during an off occasion only when the action does not depend on a transmission or a reception.
52. The method of any of Embodiments 43-51, wherein the second duration indicates a window of time within which the WD may expect a transmission from the network node or within which the WD may transmit an uplink signal.
53. The method of Embodiment 52, wherein the window of time is aligned with at least one of a discontinuous reception and a paging occasion.
54. The method of any of Embodiments 53-53, further comprising applying a first delay before triggering an action when the second timer one of starts, expires and stops during an off-occasion, and applying a second delay different from the first delay when the second timer one of starts, expires and stops during an on-occasion.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| ACK | Acknowledgement |
| AMF | Access and Mobility management Function |
| AN | Access network |
| AS | Access Stratum |
| CE | Control Element |
| CMAS | Commercial Mobile Alert System |
| CN | Core Network |
| CSS | Cross Slot Scheduling |
| CRC | Cyclic Redundancy Check |
| DCI | Downlink Control Information |
| DL | Downlink |
| DMRS | Demodulation Reference Signal |
| DN | Data Network |
| DRB | Data Radio Bearer |
| DRX | Discontinuous Reception |
| eNB | Base station in LTE |
| ETWS | Earthquake and Tsunami Warning System |
| gNB | Base station in NR |
| HARQ | Hybrid Automatic Request |
| IP | Internet Protocol |
| L2 | Layer 2 |
| L3 | Layer 3 |
| LTE | Long Term Evolution |
| MAC | Medium Access Control |
| MM | Mobility Management |
| NACK | Negative ACK |
| NAS | Non-Access Stratum |
| NDI | New Data Indicator |
| NR | New Radio |
| NW | Network |
| PC5 | A link for sidelink communication |
| PDU | Packet Data Unit |
| PDSCH | Physical Downlink Shared Channel |
| PDCCH | Physical Downlink Control Channel |
| PO | Paging Occasion |
| PF | Paging Frame |
| ProSe | Proximity-based Services |
| PSFCH | Physical Sidelink Feedback Channel |
| PSCCH | Physical Sidelink Control Channel |
| PSSCH | Physical Sidelink Shared Channel |
| PSBCH | Physical Sidelink Broadcast Channel |
| PSS | Primary Synchronization Signal |
| PDCP | Packet Data Convergence Protocol |
| RB | Radio Bearer |
| PEI | Paging Early Indication |
| RAN | Radio Access Network |
| RLC | Radio Link Control |
| RNTI | Radio Network Temporary Identifier |
| RRC | Radio Resource Control |
| RSRP | Reference Signal Received Power |
| RSRQ | Reference Signal Received Quality |
| RV | Redundancy Version |
| SCI | Sidelink Control Information |
| SL-RNTI | Sidelink-RNTI |
| SIB | System Information Block |
| SM | Session Management |
| SRB | Signaling Radio Bearer |
| SSS | Secondary Synchronization Signal |
| S-PSS | Sidelink-PSS |
| S-SSS | Sidelink-SSS |
| SSID | Sidelink Synchronization identity |
| TAI | Tracking Area Identity |
| TB | Transport Block |
| TR | Technical Report |
| UCI | Uplink Control Information |
| UE | User Equipment (Wireless device in 3GPP systems) |
| UL | Uplink |
| WD | Wireless Device |
| WG | Working Group |
| WUS | Wake-Up Signal |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node, the WD configured to:
one or both handle a timer in the WD and/or and trigger an action of the WD associated with the timer based at least in part on a network node operating in a sleeping occasion,
the triggering including at least one of:
triggering the associated action outside of the sleeping occasion when the timer has expired outside of the sleeping occasion;
triggering the associated action outside of the sleeping when the timer has expired within the sleeping occasion by delaying the triggering of the associated action to be outside of the sleeping occasion; and
triggering the associated action immediately upon expiration of the timer when the associated action does not require or depend on transmission to or reception from the network node.

2. The WD of claim 1, wherein the handling includes at least one of:
starting or restarting the timer outside of the sleeping occasion by delaying a start or restart of the timer to be outside of the sleeping occasion;
stopping the timer outside of the sleeping occasion by delaying the stop of the timer to be outside of the sleeping; and
pausing the timer when the sleeping occasion starts and resuming the timer upon end of the sleeping occasion.

3. (canceled)

4. The WD of claim 1, wherein handling the timer is independent of whether the network node is operating in the sleeping occasion, and wherein triggering includes triggering the associated action independent of whether the network node is operating in the sleeping occasion.

5. The WD of claim 4, wherein the one or both of the handling and triggering is based at least in part on the wireless device having sent a Physical Random Access Control Channel, PRACH, transmission to the network node during an on occasion of the network node or during the sleeping occasion.

6. The WD of claim 1, wherein one or both of the handling and triggering is based at least in part on the wireless device being aware of the network node operating in the sleeping occasion, the awareness as specified by a standard specification for the wireless device or as derived by an implementation behavior of the wireless device.

7. The WD of claim 1, the WD being configured to receive from the network node an indication that the network node is operating in a sleeping occasion, wherein the one or both of the handling and triggering is performed based at least in part on the received indication.

8. The WD of claim 7, wherein the indication includes at least one of:
Radio Resource Control, RRC, configuration signaling regarding one or both handling the timer and triggering the associated action;
System Information, SI, broadcast signaling regarding one or both handling the timer and triggering the associated action;
Downlink Control Information, DCI, signaling regarding one or both handling the timer and triggering the associated action; and
Media Access Control, MAC, signaling regarding one or both handling the timer and triggering the associated action.

9. The WD of claim 1, wherein the handling includes using one or both of another timer and another timer value for the another timer when the network node is operating in the sleeping occasion.

10. The WD of claim 9, the WD being configured to receive from the network node configuration information regarding one or both of the another timer and another timer value.

11.-13. (canceled)

14. The WD of claim 1, wherein the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.

15. A method implemented in a WD, the method comprising:
one or both handling a timer in the WD and triggering an action of the WD associated with the timer based at least in part on a network node operating in a sleeping occasion,
the triggering including at least one of:
triggering the associated action outside of the sleeping occasion when the timer has expired outside of the sleeping occasion;
triggering the associated action outside of the sleeping when the timer has expired within the sleeping occasion by delaying the triggering of the associated action to be outside of the sleeping occasion; and
triggering the associated action immediately upon expiration of the timer when the associated action does not require or depend on transmission to or reception from the network node.

16. The method of claim 15, wherein the handling includes at least one of:
starting or restarting the timer outside of the sleeping occasion by delaying a start or restart of the timer to be outside of the sleeping occasion;
stopping the timer outside of the sleeping occasion by delaying the stop of the timer to be outside of the sleeping; and
pausing the timer when the sleeping occasion starts and resuming the timer upon end of the sleeping occasion.

17. (canceled)

18. The method of claim 15, wherein handling the timer is independent of whether the network node is operating in the sleeping occasion, and wherein triggering includes triggering the associated action independent of whether the network node is operating in the sleeping occasion.

19. The method of claim 18, wherein one or both handling and triggering is based at least in part on the wireless device having sent a Physical Random Access Control Channel, PRACH, transmission to the network node during an on occasion of the network node or during the sleeping occasion.

20. The method of claim 15, wherein the one or both of the handling and triggering is based at least in part on the wireless device being aware of the network node operating in a the sleeping occasion, the awareness as specified by a standard specification for the wireless device or as derived by an implementation behavior of the wireless device.

21. The method of claim 15, the method further comprising receiving from the network node an indication that the network node is operating in a sleeping occasion, wherein the one or both of the handling and triggering is performed based at least in part on the received indication.

22. The method of claim 21, wherein the indication includes at least one of:
Radio Resource Control, RRC, configuration signaling regarding one or both handling the timer and triggering the associated action;
System Information, SI, broadcast signaling regarding one or both handling the timer and triggering the associated action;
Downlink Control Information, DCI, signaling regarding one or both handling the timer and triggering the associated action; and
Media Access Control, MAC, signaling regarding one or both handling the timer and triggering the associated action.

23. The method of claim 15, wherein the handling includes using one or both of another timer and another timer value for the another timer when the network node is operating in the sleeping occasion.

24. The method of claim 23, further comprising receiving from the network node configuration information regarding the one or both of the another timer and the another timer value.

25.-27. (canceled)

28. The method of claim 15, wherein the timer is one of an on-duration timer, an inactivity timer, a discontinuous reception, DRX, timer, a discontinuous transmission, DTX timer, a reference signal transmission timer, a physical random access channel, PRACH, occasion timer, an uplink timer, a downlink timer and a measurement window timer.

29.-38. (canceled)
